(19) United States
(12) Patent Application Publication
(10) Pub. No.: US 2007/0130624 A1
(43) Pub. Date: Jun. 7, 2007

(54) METHOD AND SYSTEM FOR A PRE-OS QUARANTINE ENFORCEMENT

(76) Inventors: Hemal Shah, Trabuco Canyon, CA (US); Uri El Zur, Irvine, CA (US)

Correspondence Address: MCANDREWS HELD & MALLOY, LTD, 500 WEST MADISON STREET, SUITE 3400, CHICAGO, IL, 60661, US

(21) Appl. No.: 11/566,125

(22) Filed: Dec. 1, 2006

Related U.S. Application Data
(60) Provisional application No. 60/741,383, filed on Dec. 1, 2005.

(51) Int. Cl. G06F 12/14

(52) U.S. Cl. 726/24

(57) ABSTRACT

Certain aspects of a method and system for securing an operating system are disclosed. Aspects of one method may include receiving quarantine information of an operating system prior to booting the operating system. A quarantine mechanism may be enforced based on the received quarantine information prior to booting the operating system. At the time of boot up, the pre-OS quarantine agent may provide quarantine information to the quarantine server. The quarantine server may provide quarantine related information such as OS image to boot and network resources that may be accessed by the pre-OS quarantine agent. The pre-OS quarantine agent may perform the loading of the OS image based on the health and response from the quarantine server.

### CROSS-REFERENCE TO RELATED APPLICATIONS/INCORPORATION BY REFERENCE

This application makes reference to, claims priority to, and claims the benefit of U.S. Provisional Application Ser. No. 60/741,383 (Attorney Docket No. 17222US01) filed on Dec. 1, 2005.

The above referenced application is hereby incorporated herein by reference in its entirety.

### FIELD OF THE INVENTION

Certain embodiments of the invention relate to network security. More specifically, certain embodiments of the invention relate to a method and system for a pre-operating system (OS) quarantine enforcement.

### BACKGROUND OF THE INVENTION

Network resources need to be protected from malicious users, unhealthy computers infected by computer viruses/worms, and/or malicious programs. A computer virus is a self-replicating program that may spread by inserting copies of itself into other executable code or documents. Computer viruses are one of the several types of malicious software and may be extended to refer to worms, or trojan horses, for example, and other sorts of malware. As network security concerns continue to increase, having a protected access to network resources is becoming increasingly important. There are a number of technologies being developed for network access control including 802.1x, network access protection (NAP), network admission control (NAC), trusted network connect (TNC), for example.

802.1x is an IEEE standard for port based network access control. It provides a port-to-switch authentication/authorization mechanism for devices connected on a local area network (LAN). The 802.1x enabled switch enforces network access by utilizing an external authentication server. The 802.1x enabled client provides credentials required for authentication to switch prior to accessing network resources and has been used extensively in WLAN environments. The NAC provides a set of technologies or solutions to enforce security policy compliance on all devices seeking to access network computing resources. The NAC is integrated into a network infrastructure and it utilizes switches or routers to enforce security policy compliance.

The TNC defines an open standard for network access control that defines standard interfaces for communication between components involved in providing network access control. The TNC leverages existing infrastructure and standards such as 802.1x, extensible authentication protocol (EAP), and authentication, authorization and accounting (AAA), for example. The EAP was designed to enable extensible authentication for network access in situations where the IP protocol may not be available. The EAP has subsequently also been applied to IEEE 802 wired networks, for example, IEEE-802.1X. AAA is a framework used for network management and security that controls access to computer resources by identifying unique users, authorizing the level of service, and tracking the usage mode of resources. The AAA servers may interact with network access and gateway servers, databases and directories that contain user information.

The OS-present quarantine enforcement mechanisms pose a number of challenges. The quarantine enforcement agent may be subject to the malicious attacks that the OS is subject to. This may prevent quarantine enforcement agent to execute on an unhealthy computer infected by viruses/worms. The system health information used in the OS-present environment may be subject to tampering.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

method and/or system for a pre-operating system (OS) quarantine enforcement, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1A is a block diagram of an exemplary client server architecture that may be utilized in accordance with an embodiment of the invention.

FIG. 1B is a block diagram illustrating a host with a separate network interface hardware (NIHW) block, in accordance with an embodiment of the invention.

FIG. 1C is a block diagram illustrating a host with a network interface hardware block integrated within a chipset, in accordance with an embodiment of the invention.

FIG. 2 is a block diagram that illustrates a high-level architecture for pre-OS quarantine enforcement, in accordance with an embodiment of the invention.

FIG. 3 is a flowchart illustrating pre-OS quarantine enforcement, in accordance with an embodiment of the invention.

### DETAILED DESCRIPTION OF THE INVENTION

Certain embodiments of the invention may be found in a method and system for pre-operating system (OS) quarantine enforcement. Certain aspects of the invention may provide a method and system for securing an operating system prior to booting. Exemplary aspects of the method may comprise querying system health information of an operating system prior to booting the operating system. A quarantine mechanism may be enforced based on the queried system health information prior to booting the operating system. At the time of OS boot up, the pre-OS quarantine agent may provide system health information to a quarantine server. The system health information may comprise current status of computational resources, for example, system memory and CPU resources, anti-virus updates, and OS or boot image information. The quarantine server may provide quarantine related information such as OS image to boot and network resources that may be accessed by the pre-OS quarantine agent. The pre-OS quarantine agent may perform the loading of the OS image based on the health and response from the quarantine server.

The NAP may provide various mechanisms for client/server based quarantine enforcements and supports quarantining capabilities based on dynamic host configuration protocol (DHCP), 802.1x, virtual private network (VPN), and Internet protocol security (IPSec), for example. These schemes typically use an OS-present environment with a quarantine enforcement agent running on a computer system. The quarantine enforcement agent is responsible for providing the current system health information to the quarantine server(s) that are used for monitoring the health of the computers, repairing unhealthy computers, and isolating computers that do not comply with network access policy.

In accordance with an embodiment of the invention, a pre-OS quarantine enforcement mechanism may be provided that allows a system to run a quarantine enforcement agent in an OS-absent environment prior to OS boot up. This mechanism may limit network resources' and system's exposure to damage caused by viruses or worms and also enables flexible resource usage policies prior to OS boot up. This mechanism provides an OS-independent quarantine enforcement mechanism.

In accordance with an embodiment of the invention, a pre-OS quarantine enforcement mechanism allows an IT administrator, for example, to perform preventive maintenance during boot time, for example, prior to loading the OS. Various embodiments of the invention may also provide local and remote methods for communicating system health information to the quarantine enforcement agent in an OS-absent environment. Another embodiment of the invention may enable running quarantine enforcement agents in both OS-present and OS-absent environments. The OS-absent environment may include the pre-boot and booting up stage before the OS image has been loaded. On the other hand, an OS-present environment may include the post-boot stage after the OS or boot image has been loaded. The invention also enables selection of computational resources and OS image based on the health of the system. The computational resources may include system memory resources, or CPU resources, for example.

In accordance with an embodiment of the invention, a pre-OS quarantine agent may obtain system health information locally or remotely. The pre-OS quarantine agent provides the network resources information to the OS-present components when the OS is loaded. The OS may not notice any difference between the pre-OS and OS-present enforcement clients. If the system is quarantined, then the pre-OS quarantine enforcement agent (QEA) may set up appropriate filters prior to OS loading to prevent incoming/outgoing malicious traffic. The quarantine server may coordinate the output from a plurality of system health validators (SHVs) and determine whether the pre-OS QEA should isolate a client from the network or not based on policy compliance status.

A system health validator (SHV) may validate the output from a corresponding system health agent (SHA) to verify whether the system health information complies with policy or not. A policy server may contain resources to keep network clients healthy and to provide remediation for client computers that are not healthy. The SHAs may communicate with policy servers to obtain the most recent updates. A quarantine policy may specify the required conditions for network access. A network may have more than one quarantine policy, for example, a DHCP quarantine or a VPN quarantine policy may use different quarantine policies.

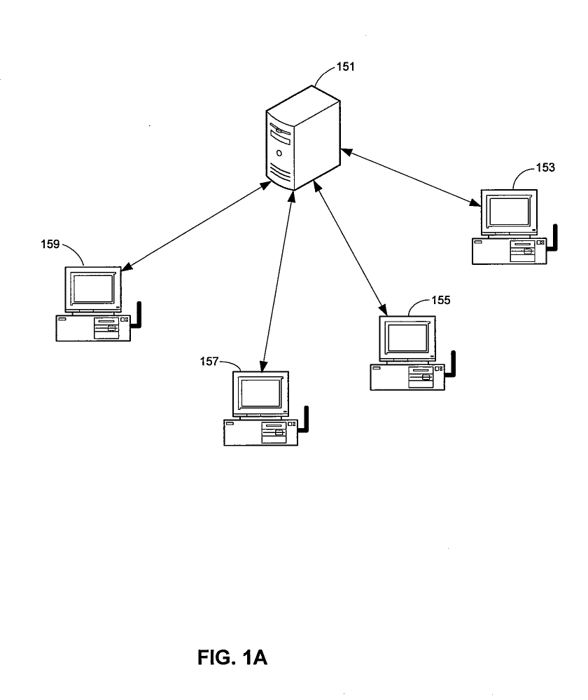

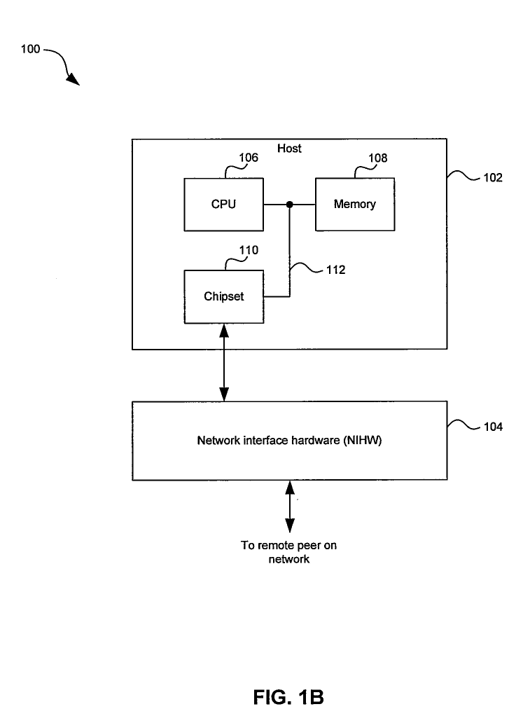

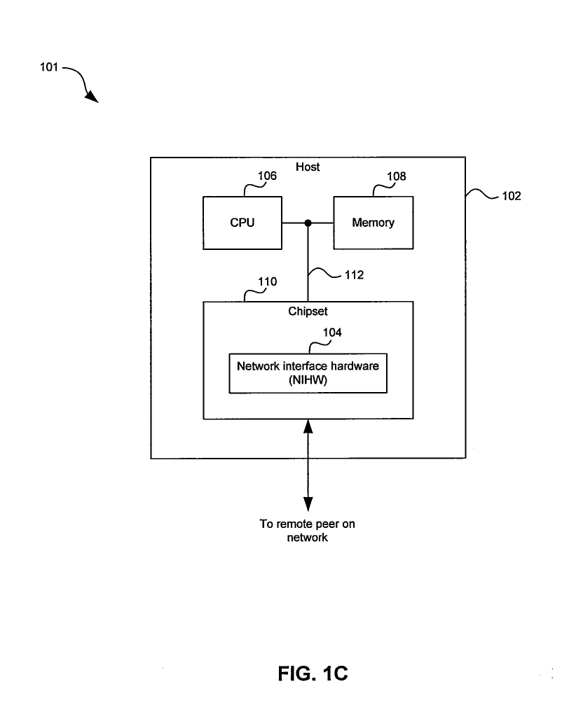

FIG. 1A is a block diagram of an exemplary client server architecture that may be utilized in accordance with an embodiment of the invention. Referring to FIG. 1A, there is shown a host 151 and a plurality of clients, client 153, client 155, client 157 and client 159. The client 153 may comprise a host processor, for example. The client 155 may comprise a dedicated service processor independent from the host processor, for example. The host 151 may comprise suitable logic, circuitry and/or code that may be enabled to limit its new connection acceptance rate or the number of suspected frames of a known profile, for example, Internet control message protocol (ICMP) in order to make sure that attacks may not disrupt its service level to legitimate clients. The host 151 may comprise a pre-OS quarantine enforcement agent that enables querying of system health information of an operating system (OS) prior to booting the OS. The pre-OS QEA may enable enforcing of a quarantine mechanism based on the queried system health information prior to booting the OS.

FIG. 1B is a block diagram illustrating a host with a separate network interface hardware (NIHW) block, in accordance with an embodiment of the invention. Referring to FIG. 1B, there is shown a networking system 100, such as a server, a client, or a similar network machine, for example, that may comprise a host 102 and a network interface hardware (NIHW) device 104. The host 102 may comprise a central processing unit (CPU) 106, a memory 108, and a chipset 110. The CPU 106, the memory 108, and the chipset 110 may be communicatively coupled via, for example, a bus 112. In another embodiment the invention, the chipset 110 may be coupled to the memory 108 through the CPU 106.

The networking system 100 may enable operation or support of various networking protocols. For example, the networking system 100 may enable supporting of transport control protocol/Internet protocol (TCP/IP) connections. In this regard, the networking system 100 may enable supporting of Internet control message protocol (ICMP), address resolution protocol (ARP), stream control transmission protocol (SCTP), and/or path maximum transmission unit (PMTU) discovery protocol, for example. The ICMP protocol may refer to an ISO/OSI layer 3 protocol that may allow routers, for example, to send error and/or control messages about packet processing on IP networks. The ARP protocol may refer to a low-level protocol within the TCP/IP suite that may map IP addresses to corresponding Ethernet addresses. The SCTP may support the transport of public switched telephone networks (PSTN) signaling messages over connectionless packet networks such as IP networks, for example. The PMTU may refer to a maximum unit of data that may be sent given a physical network medium. In other embodiments, SCTP may be used as the transport protocol rather than TCP.

The host 102 may enable setup parameters for network connections. For example, the host 102 may setup transport layer parameters comprising information that support time stamping, window scaling, delayed acknowledgment policy, flow control scheme to be used, congestion handling, selective acknowledgement (SACK), buffers to be used, and/or other transport related parameters. The host 102 may also setup network layer parameters comprising information that supports IPv4 or IPv6, for example, and options such as no fragments and/or hop limit. The host 102 may also setup data link layer parameters comprising information that supports virtual local area networks (VLAN) and source address to be used, for example.

The CPU 106 may comprise suitable logic, circuitry, and/or code that may enable supporting of the management and/or performance of networking operations associated with remote peers or clients on a network. The CPU 106 may also enable supporting of the management and/or performance of service applications that may be provided to the remote clients on the network.

The memory 108 may comprise suitable logic, circuitry, and/or code that may enable storage of information regarding the networking operations and/or service applications supported by the CPU 106. The chipset 110 may comprise suitable logic, circuitry, and/or code that may enable providing of services in support of the CPU 106 operations. For example, the chipset 110 may enable supporting of memory management, PCI master and arbitrator, graphics interface, I/O master for USB, audio, and/or peripheral devices, for example. In this regard, the chipset 110 may comprise at least one integrated circuit (IC) that provides services in support of the CPU 106 operations. In some instances, the services provided by the chipset 110 may be implemented in separate ICs. The choice of one or more ICs for implementing the chipset 110 may be based on the number and/or type of services provided.

The NIHW device 104 may comprise suitable logic, circuitry, and/or code that may enable supporting of the performance of networking operations associated with remote peers or clients on a network. The resources provided by the NIHW device 104 may support the networking operations of a maximum number remote peers or clients on a network. The NIHW device 104 may enable communication with the host 102. In this regard, the NIHW device 104 may enable communication with the CPU 106, the memory 108, and/or the chipset 110.

FIG. 1C is a block diagram illustrating a host with a network interface hardware block integrated within a chipset, in accordance with an embodiment of the invention. Referring to FIG. 1C, there is shown a networking system 101 that may differ from the networking system 100 in FIG. 1B in that the NIHW device 104 in FIG. 1B is integrated into the chipset 110. In this regard, the NIHW device 104 may enable communication with other portions of the chipset 110, and with the CPU 106, and/or the memory 108 via the bus 112. The NIHW 104 may comprise a pre-OS quarantine enforcement agent that enables querying of system health information of an operating system (OS) prior to booting the OS. The pre-OS QEA may enable enforcing of a quarantine mechanism based on the queried system health information prior to booting the OS.

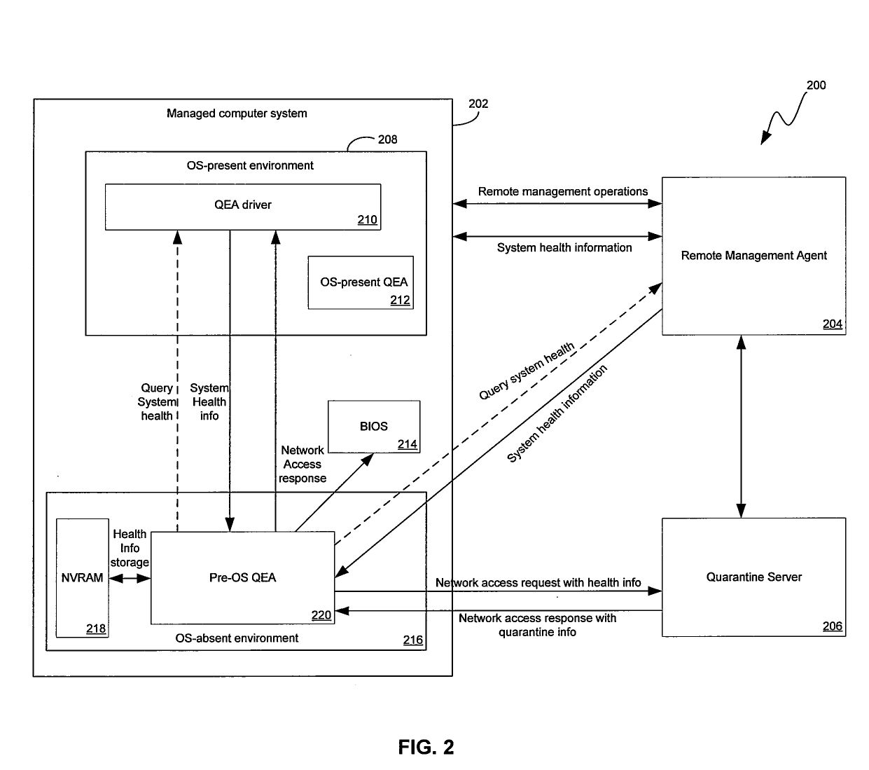

FIG. 2 is a block diagram that illustrates a high-level architecture for pre-OS quarantine enforcement, in accordance with an embodiment of the invention. Referring to FIG. 2, there is shown a high-level architecture 200 for pre-OS quarantine enforcement. The high-level architecture 200 may comprise a managed computer system 202, a remote management agent 204 and a quarantine server 206. The managed computer system 202 may comprise an OS-present environment block 208, an OS-absent environment block 216 and a BIOS 214. The OS-present environment block 208 may comprise a quarantine enforcement agent (QEA) driver 210 and an OS-present QEA 212. The OS-absent environment block 216 may comprise a non-volatile random access memory (NVRAM) 218 and a pre-OS QEA 220.

The QEA is responsible for requesting network access, providing health information to the quarantine server 206, and performing quarantining related actions such as setting up filters. The pre-OS QEA 220 may comprise suitable logic, circuitry and/or code that may enable execution in an OS-absent environment. For example, the pre-OS QEA 220 may be running in firmware of an Ethernet controller or network interface controller (NIC). The pre-OS QEA 220 may use NVRAM 218 to store system health information. As a result, the system health information may be available in both OS-present environment 208 and OS-absent environment 216. Furthermore, this storage may be made secure by integrating or providing secure storage functionality, for example, by TNC. However, the system health information may be also stored in the BIOS and retrieved by the pre-OS QEA 220. The system health information may be shared by the OS-present environment 208 and OS-absent environment 216 or may be separate.

The NVRAM 218 may comprise suitable logic, circuitry and/or code that may enable retaining of its contents when power is turned OFF. For example, a SRAM that is made non-volatile by connecting it to a constant power source such as a battery. The QEA driver 210 may comprise suitable logic, circuitry and/or code that may enable management of different quarantine enforcement agents (QEAs), for example, OS-present QEA 212 and pre-OS QEA 220. The QEA driver 210 may provide health information to the QEAs 212 and 220, and process network access responses provided by the QEAs. The QEA driver 210 may not be available during OS shutdown.

The quarantine server 206 may comprise suitable logic, circuitry and/or code that may enable processing of network access requests and providing network access responses with quarantine information based on the health of the system. The remote management agent 204 may comprise suitable logic, circuitry and/or code that may enable performing of remote management operations such as power up/down, remote configuration, and remote monitoring of the managed computer system. The basic input/output system (BIOS) 214 may comprise suitable logic, circuitry and/or code that may enable a computer to start the operating system and communicate with the various devices in the system. The BIOS 214 may comprise a set of routines or an execution environment.

The pre-OS QEA 220 may perform a plurality of steps during boot up. The pre-OS QEA 220 may send a request to the quarantine server 206 for access to the network along with the system health credentials. The pre-OS QEA 220 may determine whether this system is quarantined based on the response from the quarantine server 206. If the system is quarantined, then appropriate packet filters may be set up by the pre-OS QEA 220. The pre-OS QEA 220 may determine if the computation resource information is provided in the response from the quarantine server 206. If the computation resource information is provided in the response from the quarantine server 206, then this information may be provided to BIOS 214 and the operating system to enable the appropriate computational resources on the system. The pre-OS QEA 220 may determine if the OS or boot image information is provided in the response from the quarantine server 206. If the OS or boot image information is provided in the response from the quarantine server 206, then the appropriate image of the OS may be loaded either locally or remotely. If the OS or boot image information is not provided in the response from the quarantine server 206, the default OS may be loaded.

In an embodiment of the invention, this scheme may be expanded for network based boot solutions, by having the quarantine server 206 provide the information for the right boot image such as iSCSI target information for an iSCSI boot. The quarantine server 206 may use the system health information as a credential to provide the location of a remote boot image and a remote boot server. The quarantine server 206 may also provide credentials to allow the system to authenticate the remote boot server.

In an embodiment of the invention, the quarantine server 206 may provide information about the OS image to be loaded and the location of the OS image. The pre-OS QEA 220, BIOS 214, or a boot agent may load the OS image. If the pre-OS QEA 220 does not load the OS, the quarantine server 206 may provide information about the OS image to the appropriate agent, for example, BIOS 214 or a boot agent and then the agent may load the OS image. The quarantine server 206 may provide information to secure the loading of a remote OS image. This information may include security certificates, security protocols to use, and credentials for authentication, for example. After the OS has been loaded, the pre-OS QEA 220 may provide the network resource information to the OS. The network resource information may comprise access to network domains or partitions of the network, a set of network node addresses, for example, IP addresses, and a set of applications identified by IP addresses and/or port numbers.

In an embodiment of the invention, the quarantine server 206 may provide information that restricts the OS-absent environment 216 and the OS-present environment 208 to access the system resources. The quarantine server 206 may restrict the OS access to a particular partition of the system, for example, by providing the information for only a partition of the system resources. The quarantine server 206 may restrict the OS access to specific system memory ranges, a specific set of CPUs, or a specific set of I/O devices, for example. The quarantine server 206 may enable specific CPU address spaces, enable read/write access to configuration spaces, for example, trusted and/or non-trusted configuration spaces, or restrict access to I/O devices, for example, such that only trusted components may access them.

In an embodiment of the invention, the OS-present QEA 212 may enable querying of system health and provide that information to the pre-OS QEA 220. The querying may occur on a periodic or on a non-periodic basis. Before the OS is shutdown or hibernated, the OS-present QEA 212 or the QEA driver 210 may provide the latest system health information to the pre-OS QEA 220. The remote management agent 204 may track the system health information and provide this information to the pre-OS QEA 220 periodically or when the system health changes, for example. The pre-OS QEA 220 may query either the local agent or remote management agent 204 to obtain system health information prior to sending a network access request to the quarantine server 206.

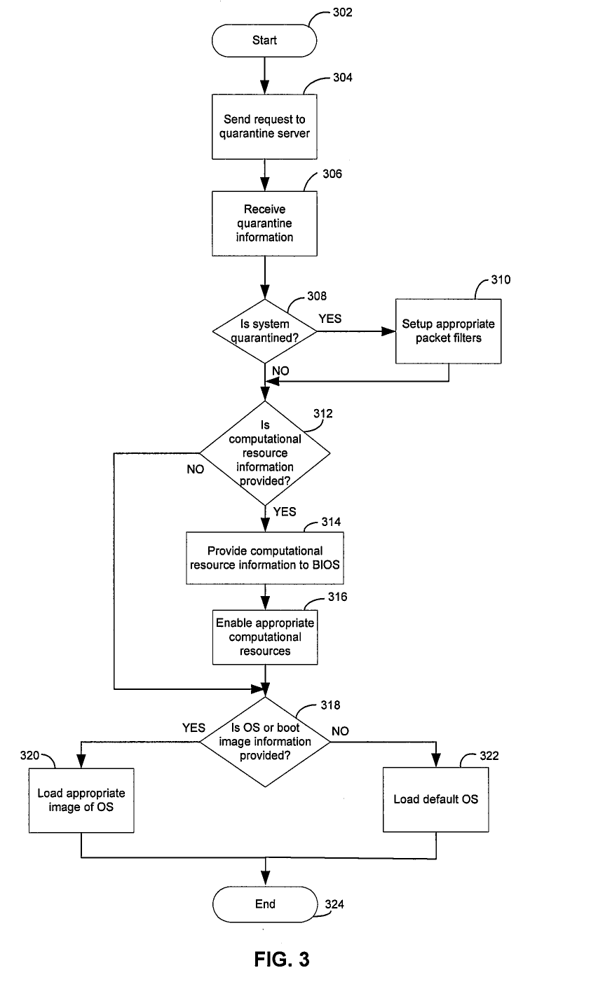

FIG. 3 is a flowchart illustrating pre-OS quarantine enforcement, in accordance with an embodiment of the invention. Referring to FIG. 3, exemplary steps may start at step 302. In step 304, the pre-OS QEA 220 may request the quarantine server 206 for accessing the network along with the system health information. In step 306, the pre-OS QEA 220 may receive the quarantine information based on the system health check from the quarantine server 206. In step 308, it may be determined whether the system is quarantined. If the system is quarantined, in step 310, the appropriate packet filters may be set up. Control then passes to step 312. If the system is not quarantined, control passes to step 312. In step 312, it may be determined whether the quarantine information received by the pre-OS QEA 220 comprises computational resource information, for example, CPU(s) and memory to be enabled. In step 312, if the quarantine information received by the pre-OS QEA 220 comprises computational resource information, control passes to step 314. In step 314, the computational resource information may be provided to the BIOS 214. In step 316, appropriate computational resources may be enabled. In step 312, if the quarantine information received by the pre-OS QEA 220 does not comprise computational resource information, control passes to step 318.

In step 318, it may be determined whether the system health information received by the pre-OS QEA 220 comprises OS or boot image information. If the quarantine information received by the pre-OS QEA 220 comprises OS or boot image information, control passes to step 320. In step 320, the appropriate OS image may be loaded. Control then passes to end step 324. If the quarantine information received by the pre-OS QEA 220 does not comprise OS or boot image information, control passes to step 322. In step 322, the default OS image may be loaded. Control then passes to end step 324.

In accordance with an embodiment of the invention, a system for securing an operating system may comprise circuitry that enables receiving quarantine information of an operating system (OS) prior to booting the OS. The pre-OS QEA 220 may enable enforcing of a quarantine mechanism based on the received quarantine information prior to booting the OS. The pre-OS QEA 220 may enable loading of an image of at least one of: the OS located locally and the OS located remotely based on the received quarantine information. The pre-OS QEA 220 may request access to a network along with the received quarantine information. The pre-OS QEA 220 may determine the operating system is quarantined based on the received quarantine information. The pre-OS QEA 220 may utilize at least one packet filter based on determining if the operating system is quarantined based on the received quarantine information. The pre-OS QEA 220 may enable selection of computational resources, for example, system memory, and CPU resources, based on the received quarantine information. The quarantine mechanism may comprise restricting access to at least one of: a portion of system memory, a portion of a plurality of central processing units, a portion of address spaces of said plurality of central processing units, and a portion of a plurality of input/output devices. The pre-OS QEA 220 may enable querying of the quarantine information before requesting access to a network. The pre-OS QEA 220 may enable receiving of the received quarantine information from a remotely coupled management agent 204, wherein the remotely coupled management agent 204 tracks the system health information. The at least one processor may encompass the pre-OS QEA 220 and the NVRAM 218. The pre-OS QEA 220 may comprise suitable logic, circuitry and/or code that may enable execution in an OS-absent environment. For example, the pre-OS QEA 220 may be running in firmware of an Ethernet controller or network interface controller (NIC). The pre-OS QEA 220 may use NVRAM 218 to store system health information. As a result, the quarantine information may be available in both OS-present environment 208 and OS-absent environment 216. The at least one processor may be at least one of: a host processor 153 (FIG. 1A), a dedicated boot processor 155, a local processor 157, and a remote processor 159.

Another embodiment of the invention may provide a machine-readable storage, having stored thereon, a computer program having at least one code section executable by a machine, thereby causing the machine to perform the steps as described above for speed negotiation for a pre-operating system (OS) quarantine enforcement.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for securing a system, the method comprising:
receiving quarantine information of a system prior to booting said system; and
enforcing a quarantine mechanism based on said received quarantine information prior to said booting said system.

2. The method according to claim 1, further comprising loading an image of at least one of: an operating system located locally and an operating system located remotely based on said received quarantine information.

3. The method according to claim 1, further comprising requesting access to network resources along with said received quarantine information.

4. The method according to claim 1, further comprising determining if said system is quarantined based on said received quarantine information.

5. The method according to claim 4, further comprising enabling at least one packet filter based on said determining.

6. The method according to claim 1, further comprising selecting computational resources based on said received quarantine information.

7. The method according to claim 1, wherein said quarantine mechanism includes restricting access to at least one of: a portion of system memory, a portion of a plurality of central processing units, a portion of address spaces of said plurality of central processing units, and a portion of a plurality of input/output devices.

8. The method according to claim 1, further comprising querying said quarantine information before requesting access to a network.

9. The method according to claim 1, further comprising receiving said quarantine information from a remotely coupled management agent, wherein said remotely coupled management agent tracks said system health information.

10. A machine-readable storage having stored thereon, a computer program having at least one code section for securing a system, the at least one code section being executable by a machine for causing the machine to perform steps comprising:
receiving quarantine information of a system prior to booting said system; and
enforcing a quarantine mechanism based on said received quarantine information prior to said booting said system.

11. The machine-readable storage according to claim 10, further comprising code for loading an image of at least one of: an operating system located locally and an operating system located remotely based on said received quarantine information.

12. The machine-readable storage according to claim 10, further comprising code for requesting access to network resources along with said received quarantine information.

13. The machine-readable storage according to claim 10, further comprising code for determining if said system is quarantined based on said received quarantine information.

14. The machine-readable storage according to claim 13, further comprising code for enabling at least one packet filter based on said determining.

15. The machine-readable storage according to claim 10, further comprising code for selecting computational resources based on said received quarantine information.

16. The machine-readable storage according to claim 10, wherein said quarantine mechanism includes restricting access to at least one of: a portion of system memory, a portion of a plurality of central processing units, a portion of address spaces of said plurality of central processing units, and a portion of a plurality of input/output devices.

17. The machine-readable storage according to claim 10, further comprising code for querying said quarantine information before requesting access to a network.

18. The machine-readable storage according to claim 10, further comprising code for receiving said quarantine information from a remotely coupled management agent, wherein said remotely coupled management agent tracks said system health information.

19. A system for securing a system, the system comprising:
at least one processor that enables receiving quarantine information of a system prior to booting said system; and
said at least one processor enables enforcing of a quarantine mechanism based on said received quarantine information prior to said booting said system.

20. The system according to claim 19, wherein said at least one processor enables loading of an image of at least one of: an operating system located locally and an operating system located remotely based on said received quarantine information.

21. The system according to claim 19, wherein said at least one processor enables requesting access to network resources along with said received quarantine information.

22. The system according to claim 19, wherein said at least one processor enables determining if said system is quarantined based on said received quarantine information.

23. The system according to claim 22, wherein said at least one processor enables at least one packet filter based on said determining.

24. The system according to claim 19, wherein said at least one processor enables selection of computational resources based on said received quarantine information.

25. The system according to claim 19, wherein said quarantine mechanism includes restricting access to at least one of: a portion of system memory, a portion of a plurality of central processing units, a portion of address spaces of said plurality of central processing units, and a portion of a plurality of input/output devices.

26. The system according to claim 19, wherein said at least one processor enables querying of said quarantine information before requesting access to a network.

27. The system according to claim 19, wherein said at least one processor enables receiving of said quarantine information from a remotely coupled management agent, wherein said remotely coupled management agent tracks said system health information.

28. The system according to claim 19, wherein said at least one processor is at least one of: a host processor, a dedicated boot processor, a local processor, and a remote processor.
